(19) United States
(12) Patent Application Publication
(10) Pub. No.: US 2009/0140855 A1
(43) Pub. Date: Jun. 4, 2009

(54) VOICE OPERATED REMINDER SYSTEM AND METHOD THEREOF

(75) Inventors: Eldad SHEMESH, Binymina (IL); Benny BATASH, Moshav Netua (IL)

Correspondence Address: OLIFF & BERRIDGE, PLC, P.O. BOX 320850, ALEXANDRIA, VA, 22320-4850, US

(73) Assignee: Eldad SHEMESH, Binymina (IL)

(21) Appl. No.: 12/327,315

(22) Filed: Dec. 3, 2008

Related U.S. Application Data
(60) Provisional application No. 60/996,720, filed on Dec. 3, 2007.

(51) Int. Cl. G08B 21/00; G10L 15/26

(52) U.S. Cl. 340/540; 704/235; 704/E15.043

(57) ABSTRACT

According to certain embodiments, there is provided a voice operated reminder system and method. In one embodiment, the system and method is configured to outputting a reminder message in accordance with a predefined rule. According to certain embodiments the system and method include, inter-alia, modules for speech processing, and reminding (including inter-alia database processing). In one embodiment, additionally or alternatively the system and method has location finding capabilities such as a global positioning system GPS receiver, and therefore the reminding module may allow location based reminders. In one embodiment, additionally or alternatively, the system and method include third party identification capabilities (for example caller id, SMS sender, and email sender) and therefore the reminding module may allow third party identification based reminders. In one embodiment, additionally or alternatively, the system and method include a timing module (e.g. calendar/clock which shows current date and time, timer which counts down, etc), and therefore the reminding module may allow time based reminders.

### CROSS REFERENCE TO RELATED APPLICATIONS

This application claims the benefit of U.S. provisional application 60/996,720 filed on Dec. 3, 2007, which is hereby incorporated by reference herein.

### FIELD OF THE INVENTION

This invention relates to reminding services, and more particularly to voice operated devices for reminding services.

### BACKGROUND OF THE INVENTION

A common problem many people suffer from is bad memory. People forget many types of information from simple activity they should do (“remember to start the washing machine before I leave the house”) as well as more complex activity or information. Memory problems become more common at the age of 50 when people start to complain of Age Associated Memory Impairment (AAMI). Forgetting important information and activities is a source for fear and frustration.

During the years, many types of products and devices were invented in order to overcome memory problems. Today most of these reminding products are applications for computer based devices such as PCs, laptops and PDAs. More recently these applications became available on mobile device such as cellular phones. One example of such application and probably the most popular one is Microsoft Outlook® software. This software provides calendar reminding services, and in addition appointment scheduling organizer and reminder. As this software is provided today in both computer and mobile devices, the reminder services are available for the user both when he is in the vicinity of his computer and when he is away from it by his mobile device.

The known reminding applications provide several types of reminding services as, for example, text, voice, combination thereof, etc. In order to have a text reminder the user has to type the date, time and the reminding message. This information is saved in a text format and the reminding text is presented to the user when the date and time is due. Alternatively, the reminding text can be converted to voice and the message played with a computerized voice.

In a voice reminder service the user records a message in his own voice. In this case, again, the message is composed of date, hour and reminding content. The message including the reminding content is converted by a speech to text application such that the computer knows when the due time has arrived. When this happened, the message is converted back to voice and played to the user.

### SUMMARY OF THE INVENTION

According to the present invention, there is provided a method for outputting a reminder message to a user comprising: receiving a reminder message; creating a rule for outputting the reminder message or a function thereof to a user, wherein the rule is based at least partly on location or third party identification; and when the rule is triggered, outputting the reminder message or a function thereof to the user.

According to the present invention, there is also provided a system for outputting a reminder message to a user comprising: an input configured to receive a reminder message; a reminding module configured to create a rule for outputting the reminder message or a function thereof to a user, wherein the rule is based at least partly on location or third party identification, the reminder module being also configured to determine when the rule is triggered; and an output configured to output said reminder message or a function thereof to the user when the rule is triggered.

According to the present invention, there is further provided a program storage device readable by machine, tangibly embodying a program of instructions executable by the machine to perform a method for outputting a reminder message to a user comprising: receiving a reminder message; creating a rule for outputting the reminder message or a function thereof to a user, wherein the rule is based at least partly on location or third party identification; and when the rule is triggered, outputting the reminder message or a function thereof to the user.

According to the present invention, there is yet further provided a computer program product comprising a computer useable medium having computer readable program code embodied therein for outputting a reminder message to a user the computer program product comprising: computer readable program code for causing the computer to receive a reminder message; computer readable program code for causing the computer to create a rule for outputting the reminder message or a function thereof to a user, wherein the rule is based at least partly on location or third party identification; and computer readable program code for causing the computer to output the reminder message or a function thereof to the user, when the rule is triggered.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of a personal device based system for voice operated reminders, according to an embodiment of the present invention;

FIG. 2 is a block diagram of a server based system for voice operated reminders, according to an embodiment of the present invention;

FIG. 3 is a flowchart of a method for database building and the inputting of reminder messages, according to an embodiment of the present invention; and

FIG. 4 is a flowchart of a method for checking and outputting reminder messages, according to an embodiment of the present invention.

### DETAILED DESCRIPTION OF EMBODIMENTS

Described herein are embodiments of the current invention for a voice operated reminder system and method. Examples of reminding capabilities include reminders based on time, geographic location and/or third party identification ID (for example phone caller ID, short message service SMS sender identification and/or Email sender identification).

As used herein, the phrase “for example,” “such as” and variants thereof describe non-limiting embodiments of the present invention.

Reference in the specification to “one embodiment”, “an embodiment”, “some embodiments”, “another embodiment”, “other embodiments”, “various embodiments”, or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” “various embodiments”, or variations thereof do not necessarily refer to the same embodiment(s).

Unless defined otherwise, all technical and scientific teens used herein have the same meaning as commonly understood by one of ordinary skill in the art to which this invention belongs. Generally (although not necessarily), the nomenclature used herein described below are well known and commonly employed in the art.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions, utilizing terms such as, “processing”, “computing”, “calculating”, “measuring, “determining”, “receiving”, “creating”, triggering”, “outputting”, “storing”, “playing”, “converting”, “attaching”, “using”, “translating”, or the like, refer to the action and/or processes of any combination of software, hardware and/or firmware.

Some embodiments of the present invention may use terms such as, processor, device, apparatus, system, block, client, sub-system, server, element, module, unit, etc, (in single or plural form) for performing the operations herein. These terms, as appropriate, refer to any combination of software, hardware and/or firmware configured to perform the operations as defined and explained herein. The module(s) (or counterpart terms specified above) may be specially constructed for the desired purposes, or it may comprise a general purpose computer selectively activated or reconfigured by a computer program stored in the computer. Such a computer program may be stored in a computer readable storage medium, such as, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed via a computing system bus.

The method(s)/algorithms/process(s) or module(s) (or counterpart terms specified above) presented in some embodiments herein are not inherently related to any particular electronic system or other apparatus, unless specifically stated otherwise. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The principles and operation of methods and systems for voice operated reminding according to the present invention may be better understood with reference to the drawings and the accompanying description.

A solution which is based on a personal device (of a user) is termed here for simplicity of description a “client solution”, “local solution” “client implementation” or “local implementation”. The personal device may be a dedicated device including any combination of software, firmware and/or hardware for providing reminder services, or the personal device may be an open platform device on which software is installed for providing reminder services. Examples of open platform personal devices include inter-alia: mobile devices (such as cellular phones, laptop computers, Personal Digital Assistants PDAs, etc) and non-mobile devices (such as public switched telephone network PSTN phones, desktop computers, etc). In one embodiment, the personal device includes inter-alia modules for speech processing, and reminding (including inter-alia database processing). In one embodiment, additionally or alternatively the personal device has location finding capabilities such as a global positioning system GPS receiver, and therefore the reminding module may allow location based reminders. In one embodiment, additionally or alternatively, the personal device includes third party identification capabilities (for example caller id, SMS sender, and email sender) and therefore the reminding module may allow third party identification based reminders. In one embodiment, additionally or alternatively, the personal device includes a timing module (e.g. calendar/clock which shows current date and time, timer which counts down, etc), and therefore the reminding module may allow time based reminders.

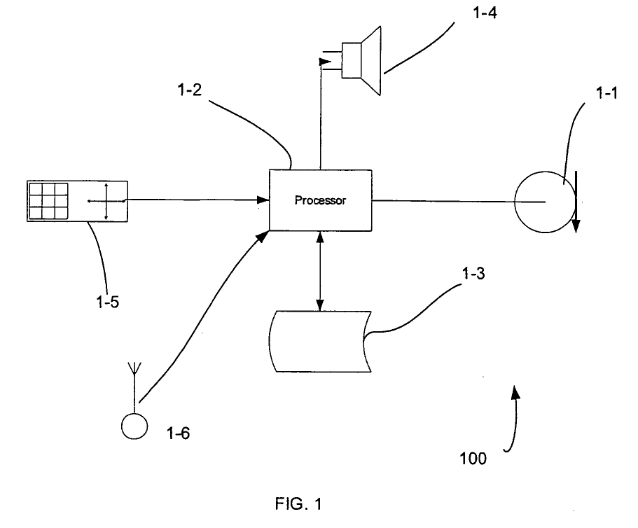

FIG. 1 illustrates system 100 for a voice operated reminder system which is composed of various modules on a personal device, according to an embodiment of the present invention. Each module illustrated in FIG. 1 may be made up of any combination of software, hardware and/or firmware which performs the functions as defined and explained herein. For the sake of example, it is assumed that the personal device is a cellular phone, although the invention is of course not limited to this example.

As illustrated in FIG. 1, the cellular phone includes the following modules: a keyboard and/or other inputting means 1-5, a reminding module, a database 1-3, a microphone (if inputs are said) 1-1, a speaker and/or other outputting means 1-4, and a GPS receiver 1-6. In one embodiment, keyboard 1-5 (or any other input means) allows for activation of the reminder system (e.g. speed dial), for answering a call, and optionally for inputting reminding information in addition to or instead of microphone 1-1. For simplicity of description it is assumed that the reminding module and optionally a speech processing module are included in a processor 1-2. In one embodiment, processor 1-2, may have a large number of functions from which only part of them are described. For example, the first function may include the processing of the keyboard strokes and the consequent activation of the reminding service. For example the second function may include speech recognition for translating the relevant part of inputted information (as explained below) to text. For example, the third function may include storing all the relevant information, as voice and/or text (as appropriate—see below) in the data base. For example, the fourth function may include looking at the database and periodically checking whether the needed rules for activating the reminding have been fulfilled, such as rules based on time, location, and/or third party identification. Continuing with the fourth function, processor 1-2 may compare incoming third party (caller/sender) identification with third party identification stored in the in database 1-3, may compare the time determined by the timer with times stored in database 1-3, and/or may compare the location determined by GPS receiver 1-6 with the stored locations in database 1-3. For example, the fifth function may include notification of and/or outputting of the reminder message. In other examples, processor 1-2 may perform more, less and/or different functions than described above. In one embodiment the (voice) reminding information via voice is fed through phone microphone 1-1, and the reminding message is played via the phone speakers 1-4, however in other embodiments, the reminding message may be inputted via other inputting means and outputted via other means (for example display). In one embodiment, the processed reminding voice and/or text (as appropriate—see below) is stored at a database 1-3. In one embodiment, GPS receiver 1-6, continuously sends the device location to the processor for calculating whether the geographic rule has been fulfilled in case of a geographic reminder. In other embodiments, the voice operated reminding system on a cellular phone may comprise more, less and/or different modules than shown in FIG. 1, and/or the functionality of the voice operated system may be divided differently among the modules. In other embodiment, the voice operated system may be composed of modules on a different personal device, for example on a desktop computer of laptop computer. In some of these other embodiments, the modules and/or functionality on a different personal device may be similar or identical to the modules and/or functionality on the cellular phone described in FIG. 1.

A centralized solution for reminders that supports large number of users termed herein a “server solution” or “server implementation”. In one embodiment of this solution, a user can use a personal device which in some cases does not have to be adapted to allow reminders (for example, in some cases there may not be a need to install any special software on a user's personal device). Examples of such personal devices include inter-alia: cellular phones, laptop computers, PDAs, PSTN phones, desktop computers, etc. In one embodiment of a server implementation, all reminder processing will take place at a remote server. In one embodiment, the server and/or personal device includes inter-alia modules for speech processing and reminding (including inter-alia database processing). In one embodiment, additionally or alternatively the server and/or personal device has location finding capabilities such as a GPS receiver, and therefore the reminding module may allow location based reminders. In one embodiment, additionally or alternatively, the server and/or personal device includes third party identification capabilities and therefore the reminding module may allow third party identification based reminders. In one embodiment, additionally or alternatively, the server and/or personal device includes a timing module, and therefore the reminding module may allow time based reminders.

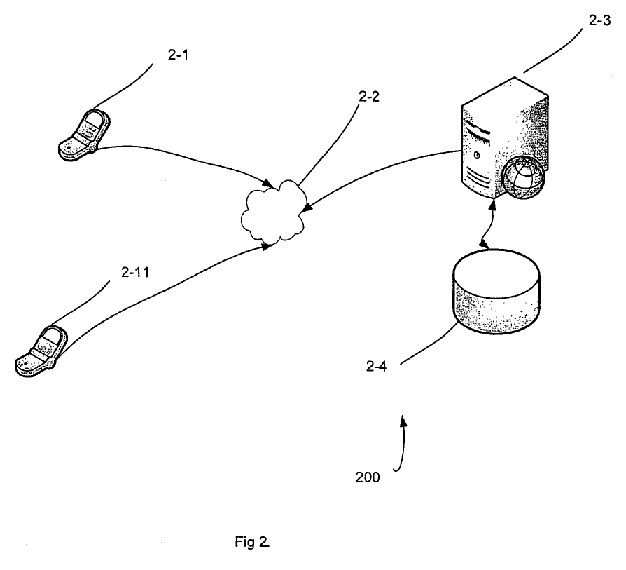

FIG. 2 illustrates a server based system 200 for voice operated reminders, according to an embodiment of the present invention. Each element illustrated in FIG. 2 may be made up of any combination of software, hardware and/or firmware which performs the functions as defined and explained herein. For the sake of example, it is assumed that the personal device element is a cellular phone, although the invention is of course not limited to this example.

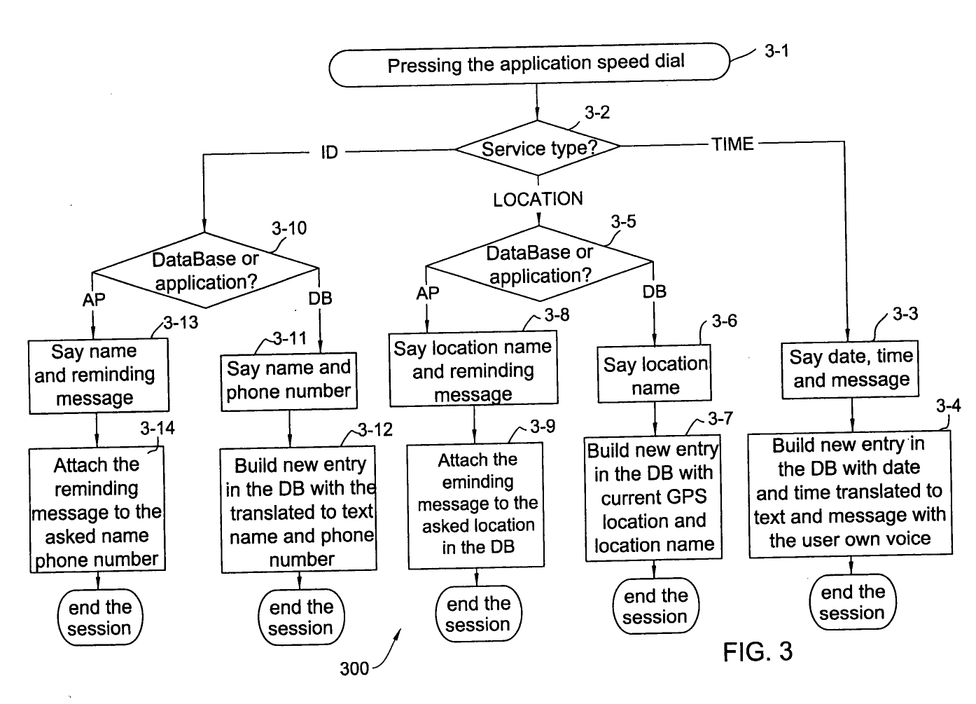

As illustrated in FIG. 2, the cellular phone 2-1 includes an input means which allows a user to activate the reminder system, for example a speed dial, or any other key/input means. The cellular phone 2-1 includes a microphone and/or other inputting means for feeding reminding information. In some cases, cellular phone 2-1 may also include a OPS receiver for establishing location entries as described with respect to FIG. 3 below. When the user uses the inputs means to activate the reminding service, phone 2-1 places a call over the phone lines 2-2 to the server 2-3. In one embodiment, when server 2-3 receives the call, the processor of server 2-3 performs similar functions to those described with reference to the processor of FIG. 1. (For simplicity of description it is assumed that the reminding module and optionally a speech processing module are included in the server processor). For example, in one embodiment, the processor of server 2-3, receives the reminding information, translates the relevant part (as explained below) of the reminding to text via speech recognition, stores the voice and/or text (as appropriate—see below) in database 2-4, checks whether the rules for reminding have been fulfilled (for example, comparing the current location of the cellular with locations in the database, comparing the time with the stored times, and/or comparing the incoming identification with the stored third party identification), and/or calls with the reminder when appropriate. In other examples, the processor may perform more, less and/or different functions than described above. In case the rules defined either time, location, third party ID or combination of the above fulfilled, the server makes a call and the reminder is played. Depending on the embodiment, the same personal device which inputted the reminder may play the reminder, or a different personal device(s) may additionally or alternatively play the reminder. Assume an embodiment where the reminder is outputted at cellular device 2-11 in addition to or instead of cellular device 2-1. In this embodiment, cellular device 2-11 (and possible 2-1) includes a speaker and/or other outputting means to output the reminder message, and in some cases a GPS receiver (if the reminder is location based) to determine the current location of the cellular device. Location can in server mode be supplied by the cellular company. Regardless of whether or not cellular phone 2-11 is capable of playing reminder messages inputted by cellular 2-1, one or more cellular phones 2-11 can work with the same server 2-3 simultaneously to cellular phone 2-1.

In other embodiments, the server-based voice operated reminding system may comprise more, less and/or different elements than shown in FIG. 2, and/or the functionality may be divided differently among the elements.

In some cases, the local solution may be considered more appropriate than server solution. For example, assuming a personal device is a cellular phone, if there is no cellular service for whatever reason, the reminding service may also not be available. As another example, a server-based reminding service may in some cases not be available due to server load etc. As another example, if the personal device is a telephone, using the reminding service may in some cases cost the user two telephone calls (local or long distance, depending where the user is present with reference to the server).

In some cases, the server solution may be considered more appropriate than the local solution. For example, if it is desired that the reminder message be played at a group of devices, the server solution may be a more efficient solution.

For ease of understanding, methods 300 and 400 are now described using a cellular phone as an example of a personal device. As explained above, however, other types of personal devices may be used instead. In embodiments which allow location based reminders, the personal device which receives a location based reminder is assumed to be mobile.

Unless otherwise stated, methods 300 and 400 described below may be implemented using reminder system 100, 200, or any other appropriate reminder system.

FIG. 3 illustrates method 300 for database building and the inputting of reminder messages, according to the embodiment of the present invention. In other embodiments, method 300 may include fewer, more, and/or different stages. In other embodiments, stages shown as sequential in method 300 may be performed in parallel and/or stages shown as being performed in parallel may be performed sequentially.

In the illustrated embodiment, it is assumed that there are 3 different types of reminding services, time-based, location-based and third party identification based reminding services (for example caller-ID, SMS, and/or email based reminding services). In the illustrated embodiment, for simplicity's sake, it is assumed that a rule is based on time, location or third party identification, however in other embodiments a reminder rule may be based on a combination of any of the above. In other embodiments, there may be more and/or different provided services, with reminder rules accordingly created.

In the illustrated embodiment, the reminder system is activated in stage 3-1. For example, the user may press a speed dial that either calls the server in case of server implementation or activates a local reminder system in case of local implementation.

In the illustrated embodiment, the user is prompted vocally in stage 3-2 for service type. For example, in some cases when the user presses a specific speed dial, the user will be asked for the type of reminding. In this embodiment, it is assumed that there are three types of reminding, the first is Date & Time based, the second is Location Based and the third is third party identification based (for example incoming caller ID based). For example, the user may need to say the service that he wants, for example using the words “TIME”, “LOCATION” or “ID”.

In another embodiment, there may be a specific speed dial for each reminding type. In another embodiment, the user may input the reminding type he wants in a different manner than saying (for example by selecting from a menu, by typing the reminding type, etc)

In the illustrated embodiment, in case the service chosen was TIME (stage 3-3), the user will be asked to feed the date, time and the reminder itself. For example, in some cases the user will feed all this information by saying the information. In some cases, when the feeding is done, the reminder system in stage 3-4 will translate the date and time to text and open a new entry in the database that holds the translated to text date and time and also holds the reminder message in the user's own voice. For example the reminder message for June 26^{th} 4 PM may be to “send the letter to Microsoft”.

In one embodiment the user will additionally or alternatively be able to feed the days/time remaining until the reminder is due rather than the date and time when the reminder should be played. The system will convert to text only the needed part of the message which is needed for knowing whether the reminder is due. These parts of the message will include fields such as date, time, location, ID etc. By converting only these fields the system will limit the exposure to speech to text vulnerabilities.

In the illustrated embodiment, in case the service chosen was LOCATION (stage 3-5), the user will be asked whether he wants to feed a new location entry to the database or input a new reminding message. For example, if the user wanted a database update, he may respond verbally with the word “DATABASE”, may select “database” from a menu, may type the word “database”, etc.

In the illustrated embodiment, in case the user asked for database update, he will be asked in stage 3-6 to feed the location name. For example, the user may say “MOTHER'S HOME” in order to create a location entry for work, may type in the words “Mother's Home”, etc.

In the illustrated embodiment, the reminder system will open a new entry in stage 3-7 in the database with the location name translated to text (if the location name was verbally expressed) and the location as determined by GPS. For example assuming again that the user fed the location name “Mother's Home”, the system may open an entry in the database with the current location (as determined by the GPS receiver) and the name “Mother's Home” (converted if necessary from speech to text). Alternatively, the system may open an entry in the database with a location position inputted by the user (not necessarily the current location) and the name “Mother's Home” (converted if necessary from speech to text). In some cases, the user will be asked to feed the vicinity value to the specified location as the rule parameter for the reminder (i.e. how close the user has to be to the specified location in order that the reminder is triggered).

In the illustrated embodiment, if the user instead wanted to feed a new location-based reminding message, he may respond verbally with the word “APPLICATION”, may select “application” from the menu, may type in “application”, etc. In case the user is asked to feed a new location based reminding message, he will be prompted in stage 3-8 for location name and the reminder itself. For example, the user may say “Mother's Home”, may type in the words “Mother's home”, etc.

In stage 3-9, the reminder system will translate the location name to text (if the location name was verbally expressed) in order to find the already established entry in the database. When this entry is found the new message will be attached to the location, optionally with the vicinity rule. For example a verbal reminder attached to mother's home may be, “give mother her present”. In another embodiment, the reminder may be translated to text and/or may be inputted in a non-verbal manner, for example by typing the message.

In the illustrated embodiment, in case the service chosen was (third party) ID, the user will be asked in stage 3-10 whether he wants to feed a new entry to the database or input a new reminding message. For example, if the user wanted a database update, he may respond verbally with the word “DATABASE”, may select “database” from a menu, may type in “database”, etc.

In the illustrated embodiment, in case the user asked for database update, he will be asked in stage 3-11 to enter the third party identification, for example third party (e.g caller) name and his phone number. The reminder system will open a new entry in stage 3-12 in the database with the third party identification (for example caller name and phone number) translated to text (if the third party identification was verbally expressed). For example, if the user entered the name and phone number as “MOTHER 03-6450328”, the reminder system will open an entry in the database with the name “MOTHER” and number 036450328 (converted if necessary to text).

In some cases, in addition to or instead of the reminding service described herein, the third party identification may be used for other functionality. For example, in one embodiment, the third party identification entries specify third parties who are allowed to leave messages for the user. For example the case of third party ID, the user may respond with “DATABASE” and the phone number of a third party that will have the privilege to leave him a message. For example “022354765”. The program will convert the number to text and add an entry in the list of privileges with the number.

In the illustrated embodiment, if the user instead wanted to feed a new third party identification-based reminding message, he may respond verbally with the word “APPLICATION”, may select “application” from the menu, may type in “application”, etc. In case the user is asked to feed a new third party identification based reminding message, he will be prompted in stage 3-13 for the identification, for example caller name, and the reminder itself. If necessary, the reminding system will translate the caller name to text to find the right entry in the DB and will attach in stage 3-14 the reminder message to that specific entry. For example, a verbal reminder attached to mother's identification may be “ask mother whether she liked the present”. In another embodiment, the reminder may be translated to text and/or may be inputted in a non-verbal manner, for example by typing the message.

In another embodiment, the establishment of a database entry for location and/or third party identification and the attachment of a reminder message may be performed simultaneously rather than separately as illustrated in FIG. 3. In another embodiment, the establishment of a database entry for time and the attachment of a reminder message may be performed separately rather than simultaneously as illustrated in FIG. 3.

In the illustrated embodiment, the speech engine has the capability to identify the rule relevant information such as TIME (e.g. date, time, time remaining, etc.), LOCATION (e.g. location name, etc), and/or ID (e.g. Caller name, etc) so that rule relevant information is translated to text but the reminder message itself is not translated to text. This operation can be made easier if the user is prompted to say rule relevant information first (for example the date and afterwards the time) and only afterwards for the reminder message. This type of feeding makes the translation easier as the algorithm has to look for a match in only a very small part of the inputted voice. In another embodiment, the reminder message may also be translated to text. In another embodiment, the user may input the rule relevant information without saying it, for example by indicating a date and time on a displayed calendar, selecting from pre-existing location/identification entries, etc and/or the user may input the reminder message without saying it, for example typing in the reminder message. In this embodiment speech to text translation may be unnecessary or may be minimized.

It should be noted that method 300 is only one way of database building and the inputting of reminder messages.

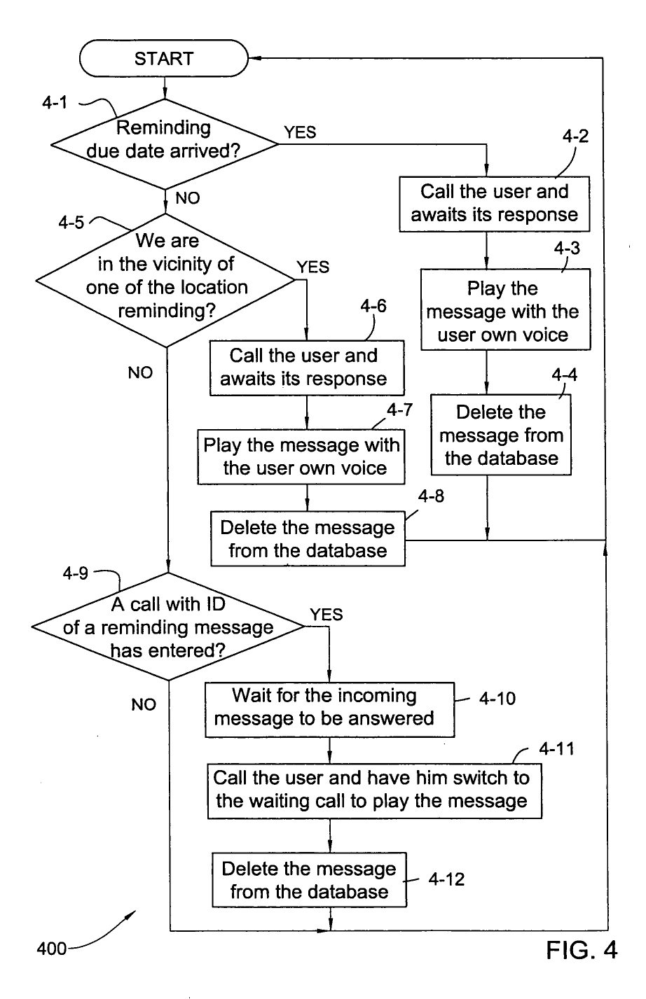

FIG. 4 illustrates method 400 for checking and outputting reminder messages, according to the embodiment of the present invention. In other embodiments, method 400 may include fewer, more, and/or different stages. In other embodiments, stages shown as sequential in method 400 may be performed in parallel and/or stages shown as being performed in parallel may be performed sequentially.

In the following, there is a detailed description for finding whether the reminder rules are fulfilled and in what way the reminder is outputted to the user. In one embodiment, the reminder system will cyclically check all the pending reminders to find out which of them has met its reminding rule.

It should be noted that depending on the embodiment of method 400, the user who inputted the reminder in method 300 may be notified of the reminder through the same personal device that was used to input the reminder, may be notified at a different personal device, and/or a user different than the user who inputted the reminder may be notified of the reminder. It should also be noted that depending on the embodiment, only one personal device may be used to output a reminder message or a plurality of personal devices may output the same reminder message (with the plurality of devices belonging for example to the same user and/or to different users). For simplicity of description of method 400 it is assumed that one user is notified per reminder message via one personal device.

In the illustrated embodiment, a routine check starts with checking whether the rule regarding the date and time (or the remaining days/time) for any TIME reminder has been met (stage 4-1). If it has been met, the reminder system will notify (stage 4-2) the user (for example by calling the user's cell phone in a server implementation or by notifying the user (for example flashing, vibrating, ringing, etc) in a local implementation. When prompted (for example when the call is answered, or the user otherwise reacts), the reminder system will play (in stage 4-3) the message in the user's own voice, in one embodiment. For example, on June 26^{th} 4 PM, the message will play “send the letter to Microsoft”. After being played, the message will be deleted in stage 4-4 from the data base and the check will move on to checking for LOCATION reminders. In another embodiment, the message can be otherwise outputted, for example, displayed.

In the illustrated embodiment, in the LOCATION check (stage 4-5), the reminder system checks whether the current device location is within the vicinity of the specified location rules, if it has such rules. If yes, the reminder system will notify the user in stage 4-6, for example by calling the user's cell phone in a server implementation or by notifying the user (for example flashing, vibrating, ringing, etc) in a local implementation. Stage 4-6 may occur, for example, when the user enters the vicinity of the specified location, and/or when leaving the vicinity of the specified location. When prompted (for example when the call is answered, or the user otherwise reacts), the reminder system will play in stage 4-7 the message in the user own voice. For example, when in the vicinity of mother's home, the message “give mother her present” will be played. After being played, the message will be deleted in stage 4-8 from the data base and the check will move on to checking for ID reminders. In another embodiment, the message can be otherwise outputted, for example, displayed.

In the illustrated embodiment, in the ID check (stage 4-9), the reminder system will check whether the cell phone is receiving a call with an id that matches the ID rule. If yes, the reminder system will wait until the call has been answered and when it has will notify the user in stage 4-10 the user, for example by calling the user and waiting until the user answers the “call waiting”. Alternatively, for a local reminding system the user may be notified by flashing, vibrating, ringing, etc. When prompted (for example when the call waiting is answered, or the user otherwise reacts), the reminding system will play in stage 4-11 the message in the user own voice. For example, when mother calls, the message “ask mother whether she liked the present” may be played. After being played, the message will be deleted in stage 4-12 from the data base and the check will move on to the TIME check again. In another embodiment, the message can be otherwise outputted, for example, displayed.

It should be noted that method 400 is only one way of checking and playing the existing reminders list.

It should be noted that some embodiments of the systems and methods described above enable optional capabilities of which a partial list is now presented:

SNOOZ: adding this feature in one embodiment enables the user to hear the message and then ask for snoozing time. For example, the user after hearing a reminder message may say or otherwise enter “snooze 15 minutes” and the reminder system will call and play the message again in 15 minutes.

Cyclic message: adding this feature in one embodiment will allow the user to add a key word (a word that is being used for checking whether the rules for message are due). For example a cyclic message may be “cyclic 8:15 give mother a call”. This message will generate a call every morning at 8:15 and when the call will be answered, the message “give mother a call” will be played.

Computer based: Some or all the above described capabilities can be implemented in some cases on a computer such that the message will be left at the computer and the reminder message will be played or otherwise outputted either at the computer or at a chosen device (such as cellular PSTN line or computer). Such capability may in some cases need the asked privileges and will be a local or web application.

Group messages: Some or all the above described capabilities can be used in some cases for groups. For example, there may be additional allowed capabilities such as defining a group and sending one or more types (e.g. time based, location based, and/or ID based) of messages to a predefined group. Continuing with the example, assuming that a conference group is defined that is called con-group, a user can create a location based reminder message for this group that is related to the conference location similar to the following “Good morning, the military session will be held at conference room 1 and the civilian at conference room 2”

Certain embodiments of the present invention may have some or all of the following advantages:
1. In some cases, the user may speak all the reminding information, rather than entering the reminding information by other means. Typically although not necessarily, speaking is more user friendly than inputting by other means such as typing.
2. In some cases only the rule relevant reminding information (such as date, time, location, third party identification etc.) necessary for activating the reminding process (method 400) is converted to text, and the reminder message itself is stored as voice. This may overcome possible disadvantages of some to speech to text software such as failure to convert reliably the speech of a user and/or failure to supports reliably more than a few languages. It is known that speech engine do not have absolute success in translating voice messages to text and therefore when the text is translated back to voice, the original and synthesized voice message are in many cases not identical.
3. In some cases reminder messages may be more closely associated with location than with time. If a location based reminder capability is provided, a user does not have to guess when a reminder that is better associated with location will be relevant.
4. In some cases, location based triggers may piggyback onto already existing location based services. As of today, Location Based Services which are services based on the user geographical locations are based mostly on content delivery. Such services includes point of interest finding needed for answering questions like “where is the nearest gas station”, in response the content provider will send back the needed information. In other cases the service provider will “push” information like “you have a car sale two blocks from here”. A new application for location based services is therefore provided by embodiments using location based triggers. For example, as discussed above with location based reminding, a reminder will be provided when the user has reached or is about to leave a specific geographic location, providing capability to leave a message like “send John an Email from work” and have it played when you reach the vicinity of work.
5. In some cases reminder messages may be more closely associated with third party identification than with time. If a third party identification based reminder capability is provided, a user does not have to guess when a reminder that is better associated with a third party will be relevant.
6. In some cases, third party identification triggers may piggyback onto already existing identification services. For example, the current ability to identify caller ID, SMS sender, or email sender enables the caller/sender to be identified to the receiving party. A new application for caller ID/sms ID/email ID services is therefore provided by embodiments using identification based triggers. For example as discussed above, with identification based reminding, a reminder to a user may be outputted when a specific third party is contacting the user.

Other advantages are evident from the discussion above.

It will also be understood that the system according to some embodiments of the present invention may be a suitably programmed computer. Likewise, some embodiments of the invention contemplate a computer program being readable by a computer for executing the method of the invention. Some embodiments of the invention further contemplate a machine-readable memory tangibly embodying a program of instructions executable by the machine for executing methods of the invention.

While the invention has been shown and described with respect to particular embodiments, it is not thus limited. Numerous modifications, changes and improvements within the scope of the invention will now occur to the reader.

1. A method for outputting a reminder message to a user comprising:
receiving a reminder message; and
creating a rule for outputting said reminder message or a function thereof to a user, wherein said rule is based at least partly on location or third party identification;
and when said rule is triggered, outputting said reminder message or a function thereof to said user.

2. The method of claim 1, wherein said reminder message is received in an audio format, further comprising:
Storing said reminder message in an audio format;
and wherein said reminder message is played back in audio format.

3. The method of claim 1, wherein said rule is triggered when a personal device of said user enters or leaves a vicinity of said location, and wherein said reminder message is played on said personal device.

4. The method of claim 3, wherein said personal device is a same personal device used for feeding said reminder message.

5. The method of claim 1, wherein said creating a rule includes:
receiving an audio indication of said location or third party identification;
converting said audio indication to text; and
attaching said reminder message to a database entry for said indicated location or third party identification.

6. The method of claim 1, further comprising:
using a global positioning system GPS to determine said location; and
creating a database entry for said determined location.

7. The method of claim 1, wherein said reminder message is received in audio format and said function is a converted text of said reminder message or said function is an audio format converted back from said converted text.

8. The method of claim 1, wherein said third party identification is a caller identification of a caller, an identification of a short message service SMS sender, or an identification of an email sender.

9. The method of claim 1, wherein said rule is triggered when said identified third party contacts said user via a personal device of said user, and wherein said reminder message is played on said personal device.

10. The method of claim 9, wherein said personal device is a same personal device used for feeding said reminder message.

11. The method of claim 1, wherein said rule is at least partly based also on time.

12. A system for outputting a reminder message to a user comprising:
an input configured to receive a reminder message;
a reminding module configured to create a rule for outputting said reminder message or a function thereof to a user, wherein said rule is based at least partly on location or third party identification, said reminding module being also configured to determine when said rule is triggered; and
an output configured to output said reminder message or a function thereof to said user when said rule is triggered.

13. The system of claim 12, wherein said input includes a microphone in a personal device.

14. The system of claim 13, wherein said input includes a network coupled between a personal device and a server.

15. The system of claim 12, further comprising a database configured to store said reminder message or a function thereof.

16. The system of claim 12, further comprising: a GPS receiver configured to determine a location of said user.

17. The system of claim 12, comprising at least two personal devices, one of which was used to input said reminder message, wherein said reminder message or function thereof is at least outputted on another of said personal devices.

18. The system of claim 12, further comprising a timing module, wherein said rule is triggered also based on time.

19. The system of claim 12, wherein said system is a local system on a personal device.

20. The system of claim 12, wherein said system at least includes a server and a personal device.

21. The system of claim 12, wherein said output includes a speaker.

22. The system of claim 12, wherein said input includes means for receiving non-audio input.

23. The system of claim 22, said system further comprising: a speech processing module.

24. The system of claim 23, wherein said input is also configured to receive an audio indication of said location or third party identification, and said speech processing module translates said indication to text.

25. The system of claim 12, wherein said output includes means for providing non-audio output.

26. The system of claim 12, wherein said reminder message is inputted via a personal device and said reminder message or function thereof is outputted via said same personal device.

27. A program storage device readable by machine, tangibly embodying a program of instructions executable by the machine to perform a method for outputting a reminder message to a user comprising:
receiving a reminder message;
creating a rule for outputting said reminder message or a function thereof to a user, wherein said rule is based at least partly on location or third party identification; and
when said rule is triggered, outputting said reminder message or a function thereof to said user.

28. A computer program product comprising a computer useable medium having computer readable program code embodied therein for outputting a reminder message to a user the computer program product comprising:
computer readable program code for causing the computer to receive a reminder message;
computer readable program code for causing the computer to create a rule for outputting said reminder message or a function thereof to a user, wherein said rule is based at least partly on location or third party identification; and
computer readable program code for causing the computer to output said reminder message or a function thereof to said user, when said rule is triggered.
